(19) United States
(12) Patent Application Publication
(10) Pub. No.: US 2021/0001243 A1
(43) Pub. Date: Jan. 7, 2021

(54) OCEANWATER DESALINATION DISTILLATION POWERED BY (HHO) HYDROGEN AND OXYGEN

(71) Applicant: Pedro Norlito Ibanez, Temecula, CA (US)

(72) Inventor: Pedro Norlito Ibanez, Temecula, CA (US)

(21) Appl. No.: 16/859,711

(22) Filed: May 14, 2020

Related U.S. Application Data
(63) Continuation-in-part of application No. 16/598,965, filed on Oct. 10, 2019, now abandoned.

(30) Foreign Application Priority Data
Aug. 7, 2019 (PH) 875040

(51) Int. Cl. B01D 1/00; B01D 1/02; B01D 3/02; B01D 5/00; C02F 1/04

(52) U.S. Cl. CPC B01D 1/0011; B01D 1/02; B01D 3/02; C02F 2103/08; B01D 5/006; C02F 1/043; B01D 5/0006

(57) ABSTRACT

The State of California has been in severe drought conditions yet ironically it is surrounded by oceanwater. Existing desalination systems require expensive electrical power to produce clean potable water. This invention creates its own electrical power input, and even EXTRA ELECTRICAL POWER to supplement California's electrical power grid (part of this inventor's other U.S. patent application Ser. No. 16/598,965.

Desalination and Distillation are two concepts that now belong to public domain and are not owned by anyone. Oceanwater is boiled and salt is left behind, in the process producing clean potable water. Steam is cooled down using cooling coils similar to car radiator, using a blower fan and oceanwater sprinklers.

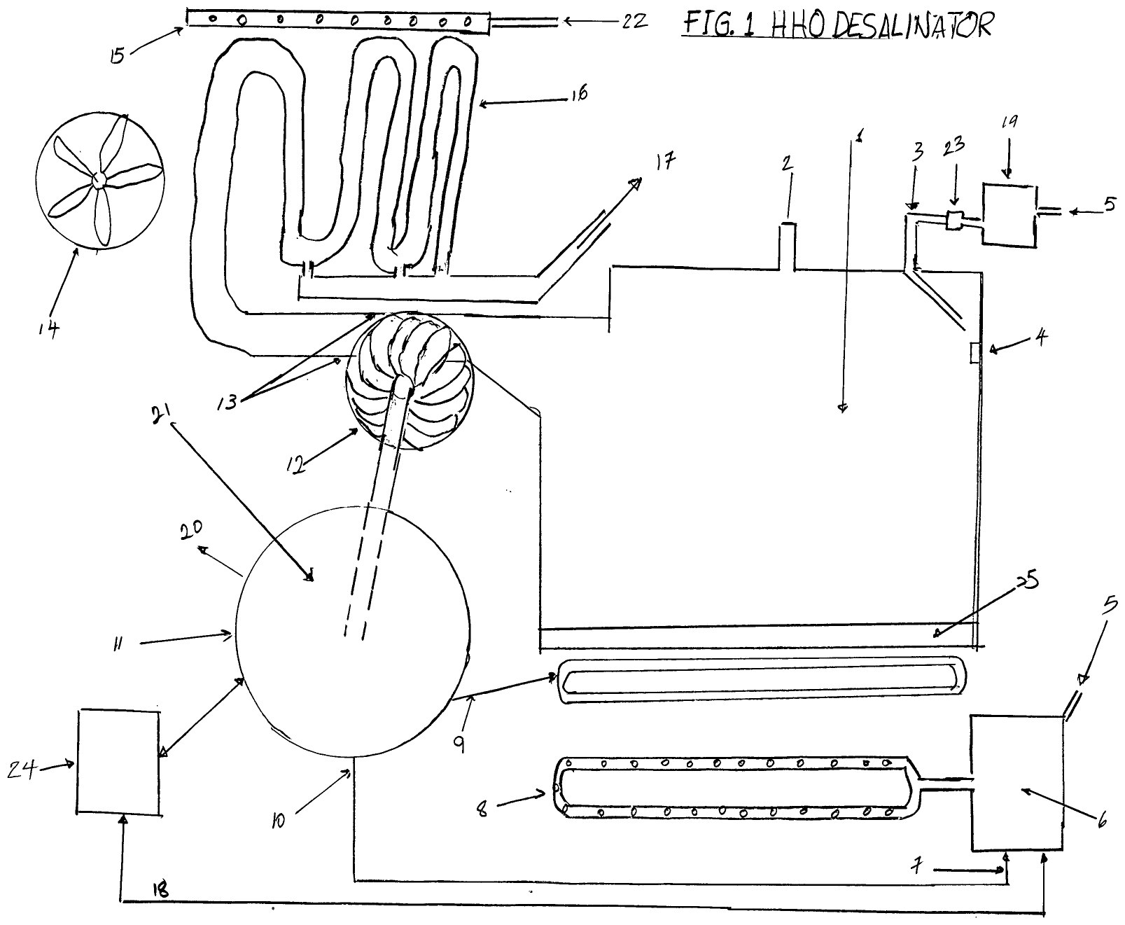

FIG. 1. DRAWING DIAGRAMS OF HHO DESALINATION DISTILLATION.

### DESCRIPTION OF PARTS

1 Steam Pressure Vessel
2 Pressure Regulator
3 Oceanwater intake thru water pumps
4 Magnetic water level regulator
5 Input from oceanwater
6 HHO Hydrogen oxygen generator
7 Output from Electrical Dynamo input to HHO GENERATOR
8 Primary Steam Boiler HHO Flame distributor
9 Output from Electrical Dynamo, input to electric heating coils, secondary steam boiler
10 Output from Electrical Dynamo to HHO GENERATOR
11 ELECTRICAL DYNAMO
12 CUP Rotators, One Way
13 1/1000^{th} inch clearance
14 Blower fan for cooling coils
15 Oceanwater sprinklers
16 Cooling coils
17 CLEAN WATER OUTPUT
18 Input output feedback regulation line from Voltage Regulator to HHO GENERATOR
19 Water pump
20 Output to water pump
21 Connecting shaft from Cup Rotators to electrical dynamo
22 Input from water pump
23 One Way valve
24 Voltage Regulator
25 Salt Extractor Drawer

DESCRIPTION: THE CONFIGURATION, COMBINATION AND /OR METHODS USING SALTWATER/OCEANWATER AND RIVERWATER IS CONVERTED TO HHO (HYDROGEN AND OXYGEN) USING ELECTROLYSIS. HHO IS USED TO BOIL WATER IN A STEAM ENGINE. STEAM PRESSURE ESCAPES AND TURNS A TURBINE FAN, WHICH TURNS TRANSMISSION GEARS. THE GEARS TURN WHEELS TO CREATE FORWARD OR REVERSE MOTION FOR CARS AND FREIGHT TRUCKS. THE GEARS TURN TURBINE BLADES OF SHIPS TO CREATE FORWARD OR REVERSE MOTION. THE CONFIGURATION, COMBINATION AND/OR METHODS OF USING HHO GENERATED FROM WATER IN AIRCRAFT JETS, HHO IS BURNED AS COMBUSTIBLE TO CREATE FORWARD MOTION. TO REFUEL, THE AIRCRAFT COMES DOWN CLOSE ENOUGH TO SEA OR RIVER LEVEL, DROPS A WATER SUCTION HOSE AND REFILLS ITS WATER TANKS.

### COMMENT

INVENTOR OBJECTS TO ANY ALLEGATION OF OBVIOUSNESS. IF THIS INVENTION IS OBVIOUS IT WOULD BE EASY TO FIND EXACT LITERATURE AND DESCRIPTION IN ANY INTERNET SEARCH ENGINE SUCH AS GOOGLE. THIS IS NOT SO AS OF FILING OF THIS APPLICATION.

CLAIM NUMBER ONE: THE COMBINATION, CONFIGURATION AND/OR METHODS OF EXTRACTING HYDROGEN AND OXYGEN (HHO) FROM WATER USING ELECTROLYSIS. HHO IS BURNED TO CREATE HEAT WHICH BOILS WATER INSIDE THE STEAM ENGINE TANK. STEAM ESCAPES AND TURNS TRANSMISSION GEARS. THE GEARS TURN WHEELS TO CREATE FORWARD OR REVERSE MOTION FOR CARS AND FREIGHT TRUCKS. THE GEARS TURN TURBINE BLADES TO CREATE FORWARD OR REVERSE MOTION FOR SHIPS.

CLAIM NUMBER TWO: THE COMBINATIONB, CONFIGURATION AND/OR METHODS OF EXTRACTING HYDROGEN AND OXYGEN (HH) FROM WATER USING ELECTROLYSIS. HHO IS USED AS COMBUSTIBE FOR AIRCRAFT ENGINES WHICH CREATE FORWARD MOTION. TO REFUEL, THE AIRCRAFT COMES DOWN CLOSE ENOUGH TO SEA OR RIVER LEVEL, DROPS A WATER SUCTION HOSE AND REFILLS ITS WATER TANKS.

CLAIM NUMBER THREE: THE COMBINATION, CONFIGURATION AND/OR METHODS OF USING ELECTROLYSIS TO EXTRACT HYDROGEN AND OXYGEN (HHO) FROM WATER AND USING THIS HHO TO HEAT AND BOIL A STEAM ENGINE.

CLAIM NUMBER FOUR: THE COMBINATION, CONFIGURATION AND/OR METHODS OF USING ELECTROLYSIS TO EXTRACT HHO FROM WATER AND USING THIS HHO AS COMBUSTIBLES FOR AIRCRAFT ENGINES.

CLAIM NUMBER FIVE: THE COMBINATION, CONFIGURATION AND/OR METHODS OF USING A SUCTION HOSE TO REFILL AN AIRCRAFT WATER TANKS, AND USING THIS WATER TO EXTRACT HHO AS COMBUSTIBLE TO PROVIDE FORWARD MOTION FOR THE JET AIRCRAFT.

What is claimed

1: The methods, combinations, configurations of several devices that safely boils oceanwater into steam. Steam is cooled using a blower fan and oceanwater sprinklers and thus steams returns to liquid as clean potable water.

2: Using inventor's other existing U.S. patent application Ser. No. 16/598,965, Primary Electrical power is supplied to this desalination system. HHO (hydrogen hydrogen oxygen) is similar to HHO welding cutting torch now popular in the welding industry. HHO can also be extracted from oceanwater. HHO is used to boil oceanwater inside Pressure Vessel tank. High pressure steam can only escape Thru a vent pipe that contains the Cup Rotators. See attached FIG. 1 Drawings. The Cup Rotators are attached to the same shaft that holds the Electrical Dynamo which , when rotated, produces the electrical input that powers the HHO generator. Voltage Regulator is a must between HHO generator and Electric Dynamo to prevent thermal runaway. Oceanwater level inside pressure vessel tank is regulated by magnetic floating level regulator. This desalination system uses water pumps to acquire nearby oceanwater. Residual salt is extracted using Salt Extractor Drawer.

3: Secondary power to heat and boil oceanwater can come from standard heater coils similar to kitchen stove heater coils only much larger, and is initially power by external 5000 watt gasoline generator. Once sufficient stream boiling is acquired, electrical input to heater coils can come from electrical dynamo.
